(19) United States
(12) Patent Application Publication
(10) Pub. No.: US 2021/0270501 A1
(43) Pub. Date: Sep. 2, 2021

(54) GEOTHERMAL-READY HEAT PUMP SYSTEM

(71) Applicant: WaterFurnace International, Inc., Fort Wayne, IN (US)

(72) Inventors: Robert R. Brown, Markle, IN (US); Christopher C. Mann, Ossian, IN (US); Christopher D. Manz, Paulding, OH (US); Brett Troy Ross, Chapin, SC (US); Willem Lange, Springdale, AR (US); Timothy C. Litton, Fort Wayne, IN (US); Bruce R. Cole, Fort Wayne, IN (US)

(21) Appl. No.: 17/186,779

(22) Filed: Feb. 26, 2021

Related U.S. Application Data
(60) Provisional application No. 62/983,072, filed on Feb. 28, 2020.

(51) Int. Cl. F25B 30/06; F25B 41/20; F25B 41/385; F25B 41/39

(52) U.S. Cl. CPC F25B 30/06; F25B 41/20; F25B 2313/002; F25B 41/39; F25B 41/385

(57) ABSTRACT

A geothermal heat pump system which may be installed in a building and operated as an air source heat pump system using an exterior heat exchanger as a heat source or heat source/sink, but which includes geothermal components including a geothermal heat exchanger. The geothermal heat exchanger may be isolated in initial operation of the system for heating and cooling but may be connected to a geothermal heat source/sink following initial installation of the heat pump system for use in heating and cooling as a heat source and a heat source/sink, respectively. In this manner, the heat pump system may be initially operated as a standard air source heat pump and optionally later converted into a geothermal heat pump system.

### CROSS-REFERENCE TO RELATED APPLICATION

This application claims the benefit of U.S. Provisional Application Ser. No. 62/983,072, filed Feb. 28, 2020 and entitled GEOTHERMAL-READY HEAT PUMP SYSTEM, the entire disclosure of which is hereby expressly incorporated herein by reference.

### BACKGROUND

### 1. Technical Field

The present disclosure relates to heat pump systems that are used to provide heating and cooling to an interior space and, in particular, the present disclosure relates to a geothermal-ready heat pump system.

### 2. Description of the Related Art

Geothermal heat pump systems utilize the earth as a heat source or heat sink for interior heating and cooling. In one type of geothermal system, a water pipe loop is buried in the ground near a building and acts as a heat source for extracting heat from the earth during the winter and a heat sink for rejecting heat into the earth during the summer. In other arrangements, water may be drawn for a well, for example, and then discharged into a pond or lake.

In geothermal systems, a standard refrigerant loop and compressor are used with an indoor heat exchanger, along with a geothermal heat exchanger in which the refrigerant is in indirect heat exchange with the water of the geothermal source. Generally, geothermal systems are more efficient than standard air source heat pump systems but require more equipment and therefore have higher initial installation costs due to the cost of installing the geothermal heat source/sink and/or connecting an existing geothermal heat source/sink to the heat pump system.

What is needed is an improvement over the foregoing.

### SUMMARY

The present disclosure provides a geothermal heat pump system which may be installed in a building and operated as an air source heat pump system using an exterior heat exchanger as a heat source or heat sink, but which includes geothermal components including a geothermal heat exchanger. The geothermal heat exchanger may be isolated in initial operation of the system for heating and cooling but may be connected to a geothermal heat source/sink following initial installation of the heat pump system for use in heating and cooling as a heat source and a heat sink, respectively. In this manner, the heat pump system may be initially operated as a standard air source heat pump and optionally later converted into a geothermal heat pump system.

In one form thereof, the present disclosure provides a heat pump system, including a compressor, a first, inside heat exchanger, a second, outside heat exchanger, a geothermal, refrigerant-to-water heat exchanger, an expansion device and a refrigerant loop. The geothermal, refrigerant-to-water heat exchanger includes a first geothermal loop connection port including a first isolation valve, and a second geothermal loop connection port including a second isolation valve. The refrigerant loop communicates the compressor, the first and second heat exchangers, the geothermal heat exchanger, and the expansion device

In another form thereof, the present disclosure provides, in combination, a building including an interior space, and a heat pump system. The heat pump system includes a first heat exchanger located within the building interior space, a second heat exchanger disposed exteriorly of the building interior space, a geothermal heat exchanger, a compressor, and an expansion device each disposed in one of the building interior space and exteriorly of the building interior space, and a refrigerant loop communicating the compressor, the first heat exchanger, the geothermal heat exchanger, the expansion device, and the second heat exchanger.

In a further form thereof, the present disclosure provides a method of operating a heat pump system, including operating an installed heat pump system to exchange heat by refrigerant flow between a first heat exchanger disposed within an interior space of a building and a second heat exchanger disposed in an ambient environment exterior to the building to heat or cool the interior space, the installed heat pump system also including a geothermal heat exchanger, connecting a water source geothermal heat source/sink to the geothermal heat exchanger, and operating the heat pump system by refrigerant flow to exchange heat between the first heat exchanger and the geothermal heat exchanger to heat or cool the interior space.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic view of a first heat pump system in accordance with the present disclosure operating in interior heating mode, and with a geothermal ground loop functionally isolated from the system and an air-source outdoor heat pump functionally integrated into the system;

FIG. 2 is a schematic view of the first heat pump system shown in FIG. 1, operating in interior cooling mode, and with the geothermal ground loop functionally integrated into the system and an air-source outdoor heat pump functionally isolated from the system;

FIG. 3 is a schematic view of a second heat pump system in accordance with the present disclosure operating in interior heating mode, and with a geothermal ground loop functionally isolated from the system and an air-source outdoor heat pump functionally integrated into the system;

FIG. 4 is a schematic view of the second heat pump system shown in FIG. 3, operating in interior cooling mode, and with the geothermal ground loop functionally integrated into the system and an air-source outdoor heat pump functionally isolated from the system;

FIG. 5 is a schematic view of a third heat pump system in accordance with the present disclosure operating in interior heating mode, and with a geothermal ground loop functionally isolated from the system and an air-source outdoor heat pump functionally integrated into the system;

FIG. 6 is a schematic view of the third heat pump system shown in FIG. 5, operating in interior cooling mode, and with the geothermal ground loop functionally integrated into the system and an air-source outdoor heat pump functionally isolated from the system;

FIG. 7 is a schematic view of a fourth heat pump system in accordance with the present disclosure operating in interior heating mode, and with a geothermal ground loop functionally isolated from the system and an air-source outdoor heat pump functionally integrated into the system;

FIG. 8 is a schematic view of the fourth heat pump system shown in FIG. 7, operating in interior cooling mode, and with the geothermal ground loop functionally integrated into the system and an air-source outdoor heat pump functionally isolated from the system;

FIG. 9 is a schematic view of a fifth heat pump system in accordance with the present disclosure operating in interior heating mode, and with a geothermal ground loop functionally isolated from the system and an air-source outdoor heat pump functionally integrated into the system;

FIG. 10 is a schematic view of the fifth heat pump system shown in FIG. 9, operating in interior cooling mode, and with the geothermal ground loop functionally integrated into the system and an air-source outdoor heat pump functionally isolated from the system;

FIG. 11 is a schematic view of an air-source interior heat exchanger usable with any of the heat pump systems in accordance with the present disclosure; and

FIG. 12 is a schematic view of a fluid-source interior heat exchanger usable with any of the heat pump systems in accordance with the present disclosure.

Corresponding reference characters indicate corresponding parts throughout the several views. Although the exemplifications set out herein illustrate embodiments of the invention, the embodiments disclosed below are not intended to be exhaustive or to be construed as limiting the scope of the invention to the precise form disclosed.

### DETAILED DESCRIPTION

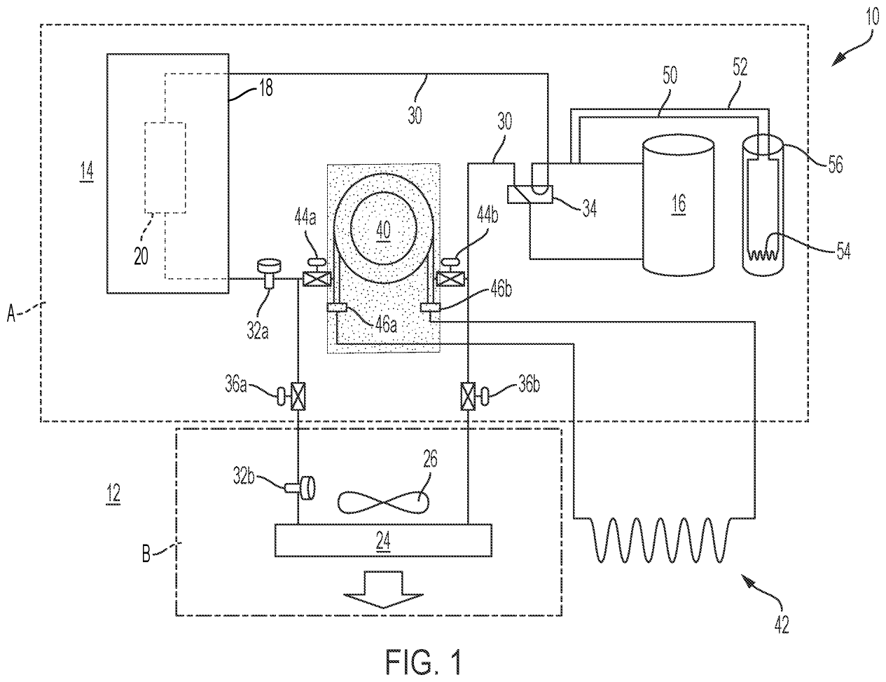

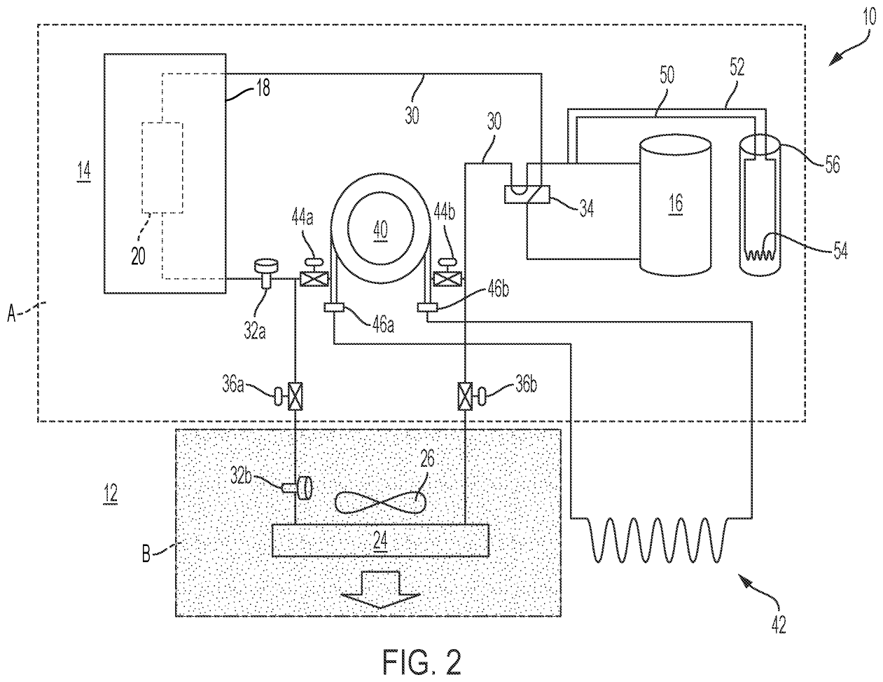

Referring to FIGS. 1 and 2, schematic views of a heat pump system 10 in accordance with the present disclosure are shown, wherein components that are installed internally within a building space are surrounded by bounding box A, and other components of the system which are disposed externally of the building in the ambient environment 12 are surrounded by bounding box B. The building may be a residential building such as a house, apartment or condominium, for example, or may be a commercial structure, and generally includes an interior space 14 to be heated or cooled in the manner described below.

Throughout FIGS. 1-10, components functionally inoperable in either the heating or cooling modes of system 10 are shown with darkened stippling around such functionally inoperable components. For purposes of the present disclosure, components are “functionally inoperable” or “functionally isolated” when such components do not participate in the phase, enthalpy, heat content or other physical properties of the refrigerant in refrigerant loop 30, except through incidental energy losses resulting from conveyance of the refrigerant. For example, a heat exchanger is “functionally isolated” or inoperable when it is bypassed by refrigerant passing through loop 30. By contrast, components are “functionally operable” or “functionally integrated” when such components intentionally change the phase, enthalpy, heat content or other physical properties of the refrigerant in refrigerant loop 30. Therefore, a heat exchanger is “functionally integrated” or operable when it refrigerant passes through the heat exchanger and exchanges heat with another fluid before advancing downstream via refrigerant loop 30.

The heat pump system 10 includes a compressor 16, which may be a single compressor, or a bank of several compressors operated together, for example. Compressor 16 may be a scroll compressor or alternatively, may be a reciprocating piston compressor, rotary compressor, screw compressor, or other type of compressor which operates to compress a refrigerant working fluid, with compressor 16 disposed within interior space 14 of the building and optionally packaged as a separate, stand-alone unit.

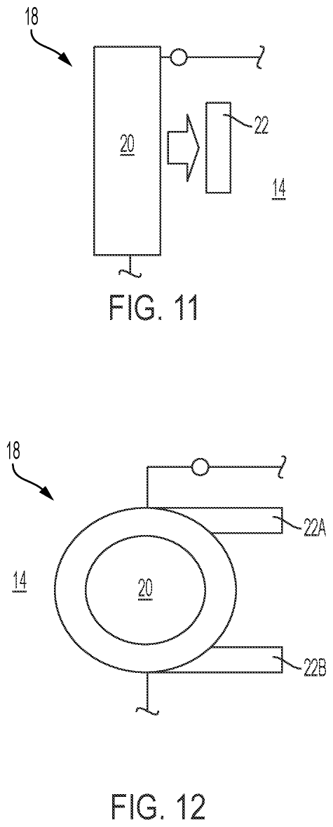

Heat pump 18 includes a first, indoor heat exchanger 20, as further described below with respect to FIGS. 11 and 12, which is also disposed in interior space 14 of the building. In operation, during heating of interior space 14 (FIG. 1), the heat exchanger 20 of heat pump 18 operates as a condenser. Conversely, during cooling of interior space 14 (FIG. 2), the heat exchanger 20 of heat pump 18 operates as an evaporator.

In one embodiment of heat pump system 10 shown in FIG. 11, heat pump 18 includes an air source heat exchanger 20 such as an indoor air coil, for example, including a fan 22 for moving air around/through heat exchanger 20. Heat exchanger 20 discharges heat to the air of interior space 14 in heating mode (FIG. 1), via air flow over coils or other heat-exchange surfaces of heat exchanger 20. When fan 22 is activated, the air flow is increased, extracting additional heat from the refrigerant loop. In cooling mode, heat is extracted by heat exchanger 20 in the same manner.

In an alternative embodiment of heat pump system 10 shown in FIG. 12, heat pump 18 includes a hydronic or fluid-source heat exchanger 20. In this embodiment and in the heating mode of system 10, heat exchanger 20 discharges heat from the refrigerant loop to a second fluid loop in heat-exchange communication with interior space 14. This second fluid loop is configured to efficiently exchange heat from the refrigerant loop to the second fluid loop, but the two loops are fluidly isolated from one another. As heated fluid discharges from heat exchanger 20 via discharge conduit 22A, it is circulated through interior space (e.g., via radiators or other radiant-heat units), discharging heat to interior space 14. Cooler fluid is returned to heat exchanger 20 via return conduit 22B to be warmed again. In cooling mode, heat is extracted by heat exchanger 20 in the same manner.

Turning again to FIG. 1, a second, outdoor heat exchanger 24 is disposed in the ambient environment 12 externally of the building and may be an air source heat exchanger including a fan 26 for moving air around/through heat exchanger 24. In operation, during heating of interior space 14, heat exchanger 24 operates as an evaporator and during cooling of interior space 14, heat exchanger 24 operators as a condenser.

Refrigerant loop 30 carries a suitable refrigerant working fluid and includes conduits fluidly connecting compressor 16, the heat exchanger 20 of heat pump 18, and second heat exchanger 24. Refrigerant loop 30 also includes a pair of expansion devices 32a and 32b, a four-way valve 34, and isolation valves 36a and 36b associated with the refrigerant inlet/exits of outdoor heat exchanger 24. As discussed below, expansion device 32a is located proximate indoor heat exchanger 20 and operates when the heat pump system 10 is in interior heating mode (FIG. 1), and expansion device 32b is located proximate outdoor heat exchanger 24 and operates when the heat pump system 10 is in interior cooling mode (FIG. 2).

The refrigerant loop 30 additionally includes a geothermal heat exchanger 40, which may be a coaxial refrigerant-to-water heat exchanger or a brazed plate refrigerant-to-water heat exchanger, for example for transferring heat between the refrigerant in refrigerant loop 30 and a water source geothermal heat source/sink 42. Geothermal heat exchanger 40 includes isolation valves 44a and 44b associated with the water inlet/exits of geothermal heat exchanger 40 to isolate geothermal heat exchanger 40 from refrigerant loop 30 following initial installation and operation of heat pump system 10 when geothermal heat exchanger 40 is not in use, as described below and shown in FIG. 1. Geothermal heat exchanger 40 also includes a pair of connection ports 46a and 46b for connecting geothermal heat exchanger 40 to water source geothermal heat source/sink 42.

Geothermal heat source/sink 42 is a water source geothermal heat source/sink in which water is in indirect heat exchange with surrounding soil and/or water, and may be an earth/ground loop, well, or pond, for example, and operates as heat source when heat pump system 10 is in interior heating mode and a heat sink when heat pump system 10 is in interior cooling mode.

Heat pump system 10 may be initially installed with compressor 16, indoor heat exchanger 20, expansion device 32a, and geothermal heat exchanger 40 with its associated isolation valves 44a and 44b and connection ports 46a and 46b, and associated lines of refrigerant loop 30 together packaged as a single unit and disposed within interior space 14 of the building such that, following installation and during subsequent operation, the foregoing components are each physically disposed within interior space 14 of the building as shown by interior bounding box A. Outdoor heat exchanger 24 and its isolation valves 36a and 36b, expansion device 32b, and associated lines of refrigerant loop 30, may also be packaged as a separate unit and installed in the ambient environment 12 externally of the building as shown by exterior bounding box B.

After initial installation, heat pump system 10 may be operated as a standard heat pump system to heat or cool interior space 14 by heat exchange using refrigerant flow through refrigerant loop 30 between first heat exchanger 20 disposed within interior space 14 of the building and second heat exchanger 24 disposed in ambient environment 12 exterior to the building. This standard heat pump configuration is schematically shown in FIG. 1 by the darkened stippling shown around geothermal heat exchanger 40, indicating that heat exchanger 40 is functionally isolated from the other components of system 10 and therefore does not participate in the heating or cooling function of the system. Suitable thermostats and controls (not shown) may be used to operate and coordinate the functioning of compressor 16, fans 22 and 26, four-way valve 34, and thermal expansion devices 32a and 32b.

Referring to FIG. 1, in an interior heating mode following initial installation, isolation valves 44a and 44b associated with geothermal heat exchanger 40 are closed and isolation valves 36a and 36b associated with outdoor heat exchanger 24 are open. In this manner, geothermal heat exchanger 40 is isolated from refrigerant loop 30 while outdoor heat exchanger 24 is operational within refrigerant loop 30. Compressor 16 compresses and discharges the refrigerant within refrigerant loop 30, which is directed to indoor heat exchanger 20 where heat from refrigerant is rejected into interior space 14, followed by expansion of the refrigerant by expansion device 32a. The refrigerant then passes to outdoor heat exchanger 24 to absorb heat from ambient environment 12 before returning to the suction inlet of compressor 16.

For an interior cooling mode following initial installation, the arrangement of system 10 shown in FIG. 1 is maintained but four-way valve 34 is switched to the configuration of FIG. 2. In this cooling mode, discharged, compressed refrigerant is directed from compressor 16 to outdoor heat exchanger 24 by the alternate path established by four-way valve 34 (FIG. 2), where heat is rejected into the ambient environment 12, followed by expansion of the refrigerant by expansion device 32b. The refrigerant then passes to indoor heat exchanger 20 to absorb heat from interior space 14 before returning to the suction inlet of the compressor 16.

Advantageously, according to the present disclosure and as shown in FIG. 2, at a time following initial installation of heat pump system 10, a geothermal heat source/sink 42 may be connected to geothermal heat exchanger 40 using connection ports 46a and 46b of geothermal heat exchanger 40. A suitable pump (not shown) may be used to circulate water through geothermal heat source/sink 42 to transfer heat between the water in geothermal heat source/sink 42 and the earth, and heat is also transferred in geothermal heat exchanger 40 between the water in geothermal heat source/sink 42 and the refrigerant in refrigerant loop 30.

As illustrated in FIG. 2, isolation valves 44a and 44b associated with geothermal heat exchanger 40 may be opened to place geothermal heat exchanger 40 in an operational condition within refrigerant loop 30, such that geothermal heat exchanger 40 becomes functionally integrated with the other components of system 10 as shown by the lack of darkened stippling shown around geothermal heat exchanger 40. At the same time, isolation valves 36a and 36b associated with outdoor heat exchanger 24 may optionally be closed to isolate outdoor heat exchanger 24 from refrigerant loop 30, such that heat exchanger 24 is functionally isolated from the other components of system 10 as shown by the presence of darkened stippling shown around geothermal heat exchanger 40 and the other components within exterior bounding box B. In this manner, the operation of outdoor heat exchanger 24 in heat pump system 10 is replaced with that of geothermal heat exchanger 40.

Specifically, in an interior heating mode following installation of geothermal heat exchanger 40, compressor 16 compresses and discharges the refrigerant, which is directed to indoor heat exchanger 20 where heat from the refrigerant is rejected into interior space 14, followed by expansion of the refrigerant by expansion device 32a. The refrigerant then passes to geothermal heat exchanger 40 to absorb heat from geothermal heat source/sink 42 before returning to the suction inlet of compressor 16. This mode corresponds to the general configuration of FIG. 2, but with four-way valve 34 configured as shown in FIG. 1, it being understood that the heating and cooling modes are available to system 10 regardless of whether outdoor heat exchanger 24, geothermal heat exchanger 40, or both are functionally integrated with the other components.

Referring to FIG. 2, in an interior cooling mode following installation of geothermal heat exchanger 40, discharged, compressed refrigerant is directed from compressor 16 to geothermal heat exchanger 40 via valve 34. There, heat is rejected into geothermal heat source/sink 42, followed by expansion of the refrigerant by expansion device 32a. The refrigerant then passes to indoor heat exchanger 20 to absorb heat from interior space 14 before returning to the suction inlet of the compressor 16.

Alternatively, following installation of geothermal heat exchanger 40, both outdoor heat exchanger 24 and geothermal heat exchanger 40 may be used in a either a switched, single operational mode or in a dual or concurrent operational mode in both heating and cooling of interior space 14, in which both isolation valves 36a and 36b associated with outdoor heat exchanger 24 and isolation valves 44a and 44b associated with heat exchanger 40 are in an open position.

Specifically, in an interior heating mode, compressor 16 compresses and discharges the refrigerant, which is directed to indoor heat exchanger 20 where heat from the refrigerant is rejected into interior space 14, followed by expansion of the refrigerant by expansion devices 32a. The refrigerant then passes either selectively through one of outdoor heat exchanger 24 and geothermal heat exchanger 40 to absorb heat from the ambient environment 12 or geothermal heat source/sink 42, respectively, before returning to the suction inlet of compressor 16, or passes concurrently through both outdoor heat exchanger 24 and geothermal heat exchanger 40 to absorb heat from the ambient environment 12 and geothermal heat source/sink 42 before returning to the suction inlet of compressor 16.

Referring to FIG. 2, in an interior cooling mode, discharged, compressed refrigerant is directed from compressor 16 either selectively through one of outdoor heat exchanger 24 and geothermal heat exchanger 40, where heat is rejected into ambient environment 12 or geothermal heat source/sink 42, respectively, or passes concurrently through both outdoor heat exchanger 24 and geothermal heat exchanger 40 to reject heat into both ambient environment 12 and geothermal heat source/sink 42, followed by expansion of the refrigerant by expansion device 32a. The refrigerant then passes to indoor heat exchanger 20 to absorb heat from interior space 14 before returning to the suction inlet of the compressor 16.

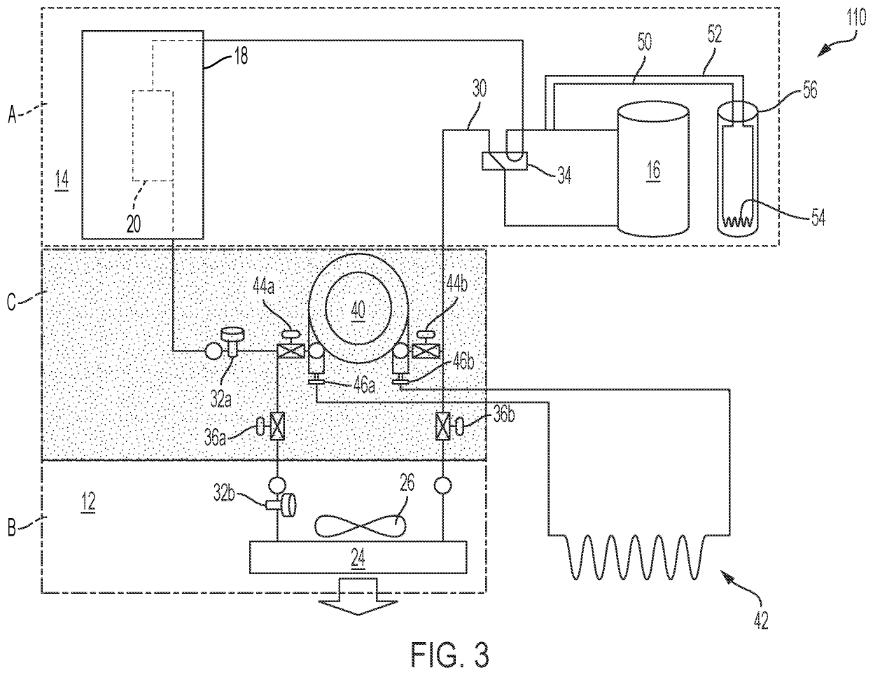

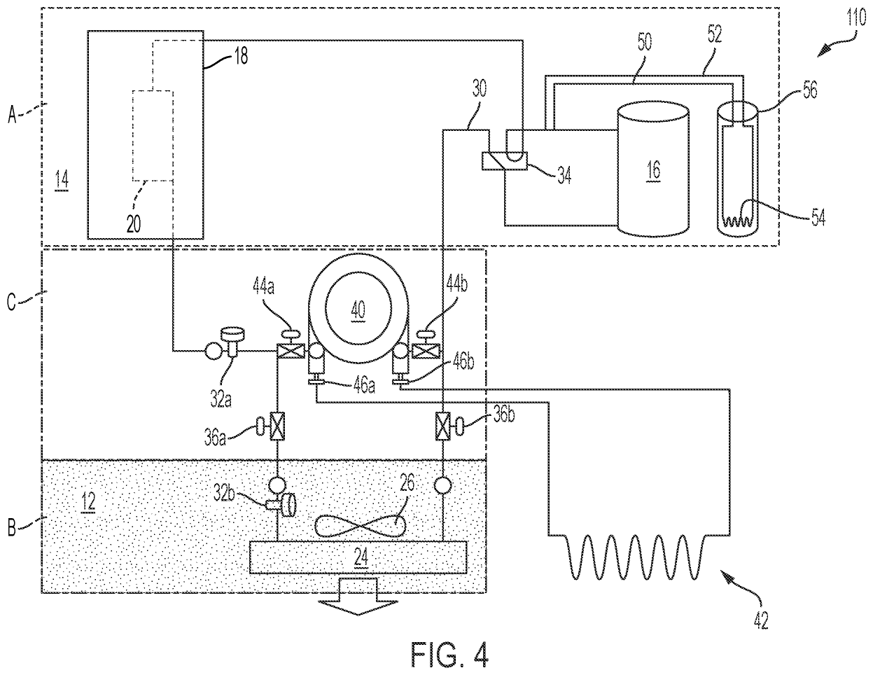

FIGS. 3-10 show additional heat pump systems 110, 210, 310 and 410 each sharing common components with system 10. Corresponding structures and components either have the same reference number, or where modifications are present, a corresponding reference number to system 10 except with 100, 200, 300 or 400 added thereto. Except as otherwise described below, systems 110, 210, 310 and 410 have the same features and functions as system 10. In addition, FIGS. 3, 5, 7 and 9 show heating modes with functionally isolated geothermal heat exchanger 40, while FIGS. 4, 6, 8 and 10 show cooling modes with functionally isolated outdoor heat exchanger 24. As noted above with respect to FIGS. 1 and 2, both heating and cooling modes may be used in any configuration of functionally isolated or integrated heat exchangers 24, 40, depending on the configuration of valve 34.

Advantageously, system 10 facilitates servicing of compressor 16 by the location of compressor within the building, e.g., as a stand-alone unit. Further, in system 10, outdoor heat exchanger 24 and its associated expansion device 32b and isolation valves 36a and 36b together form a minimized packaged unit which reduces the overall footprint of the exterior components of heat pump system 10 located outside of the building in ambient environment 12.

Referring still to FIGS. 1 and 2, heat pump system 10 may optionally include a hot water heating function in which hot water heater refrigerant lines 50 and 52 are connected to refrigerant loop 30, optionally via suitable valves, to convey refrigerant from the discharge side of compressor 16 to heat exchanger 54 of hot water tank 56 to heat hot water within tank 56 for supply to the building in both the heating cooling modes of operation shown in FIGS. 1-10.

Advantageously, the hot water heating function is facilitated by the location of compressor 16 within interior space 14 in the building, as opposed to other heat pump configurations in which a compressor is located outside of the building in ambient environment 12 and is packaged with or otherwise associated with outdoor heat exchanger 24. In particular, hot water tank 56 and heat exchanger 54 may operate as a “desuperheater” within the context of refrigerant loop 30, increasing the overall efficiency of the system from an energy-recovery and overall energy use perspective.

Turning now to FIGS. 3 and 4, an alternative configuration in accordance with the present disclosure is shown as heat pump system 110. System 110 includes bounding box A, in which fewer components are contained within interior space 14 as compared to the configuration of FIGS. 1 and 2. In particular, geothermal heat exchanger 40 has is located within bounding box C, together with its associated components including expansion device 32a, isolation valves 36a and 36b, isolation valves 44a and 44b, and connection ports 46a and 46b. In an exemplary embodiment, bounding box C is representative of a cabinet or enclosure placed outside of the building in ambient environment 12, which may facilitate retrofit applications where interior space is limited or other spatial or technical constraints preclude placement of geothermal heat exchanger 40 within interior space 14.

In one embodiment, bounding box C may represent one outdoor cabinet, and bounding box B may represent another, separate outdoor cabinet. This allows the two cabinets to be placed in different locations around the building, which may be desired for some installations. Alternatively, bounding boxes B and C may be combined into a single outdoor cabinet where spatial and technical installations considerations permit.

As shown in FIG. 3, the heat exchange components contained within bounding box C may be functionally isolated from the other components of system 10 when operating without geothermal heat source/sink 42 while still allowing passage of refrigerant, while the heat exchange components within bounding box B may be functionally integrated with the other components. Conversely, when geothermal heat source/sink 42 becomes installed and/or available to system 10, the components within bounding box C are functionally integrated as shown in FIG. 4. The components in bounding box B may then be functionally isolated, as shown, or may optionally remain functionally integrated if both heat exchangers 24 and 40 if it is desired to have both heat exchangers working in parallel.

System 110 retains the benefits of a small, compact outdoor cabinet for bounding box B, as also discussed above with respect to system 10 above. In addition, the second outdoor cabinet of bounding box C allows for outdoor installation of additional components, which may be advantageous where space in ambient environment 12 is relatively more plentiful as compared to space within the building's interior space 14. System 110 of FIGS. 3 and 4 may also optionally include hot water tank 56 having heat exchanger 54, as noted above with respect to system 10 in FIGS. 1 and 2.

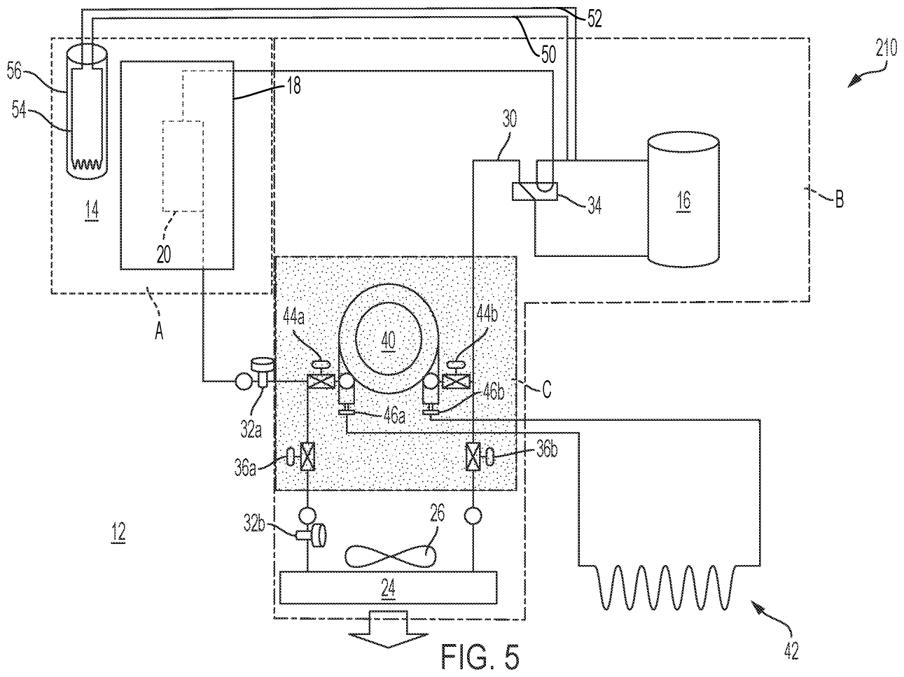

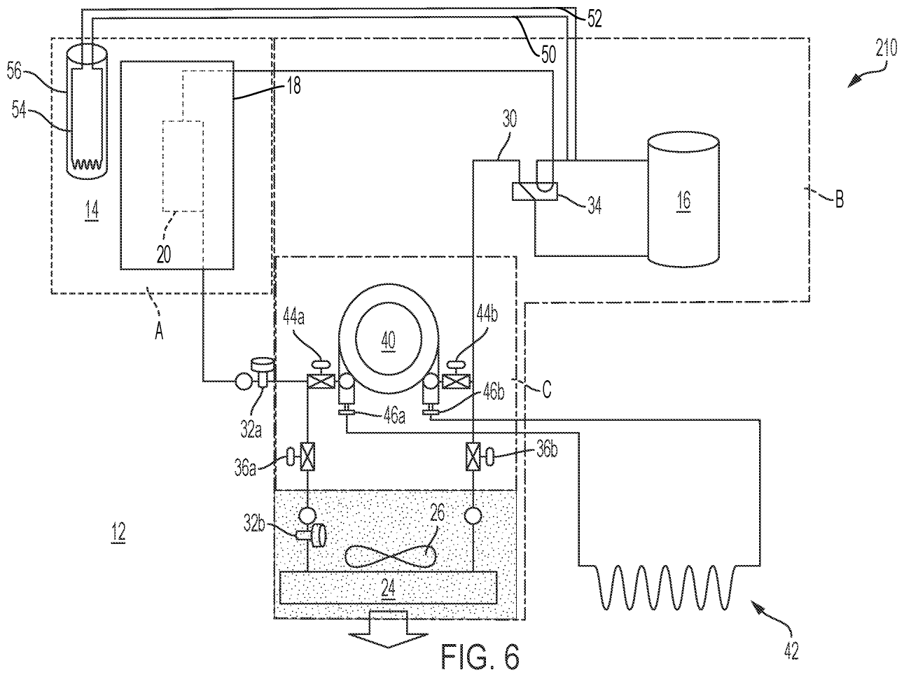

Turning to FIGS. 5 and 6, another alternative configuration in accordance with the present disclosure is shown as heat pump system 210. System 210 includes bounding box A, in which even fewer components are contained within interior space 14 as compared to the configuration of FIGS. 3-4. In particular, interior space 14, as shown by bounding box A, including only the interior heat pump 18 and, optionally, hot water tank 56 and associated components as further described below. All the remaining components, including heat exchangers 24 and 40 and their associated components, may be contained outside the building as shown by bounding box B. Bounding box B may be indicative of a large outdoor cabinet of sufficient size to house outdoor heat exchanger 24, geothermal heat exchanger 40, compressor 16 and the various associated valves and components as shown in FIGS. 5 and 6.

Additionally, bounding box C illustrates a sub-compartment either within bounding box B, i.e., contained within the same large cabinet, or separate, i.e., including a separate outdoor cabinet. Bounding box C contains the components which are inactive when geothermal heat exchanger 40 and its associated components are functionally isolated from the other components of system 210, i.e., when geothermal heat source/sink 42 is not yet installed and/or operational as illustrated in FIG. 5. FIG. 6 shows the components within bounding box C integrated into system 210, and outdoor heat exchanger 24 and its expansion device 32b optionally isolated as described above with respect to systems 10 and 110.

System 210 shown in FIGS. 5 and 6 allows for retrofit of many existing heat pump systems in which the compressor, condenser, and outdoor heat exchanger are all located in a single large cabinet located outside the building. These existing heat pump systems typically transfer heated or cooled refrigerant to the interior of the building for heat exchange, e.g., via a forced-air or radiant interior heat distribution system. System 210 may be offered as a direct replacement for such “large cabinet” outdoor units which also offers geothermal connectivity in accordance with the present disclosure.

Hot water tank 56 and heat exchanger 54 may still be optionally included in system 210, within bounding box A and interior space 14 as described above. Where it is desired to include these components in system 210, refrigerant lines 50 and 52 may extend across the thermal envelope of the building from the ambient environment 12, including the cabinet of bounding box B (containing compressor 16) to the hot water tank 56 in interior space 14.

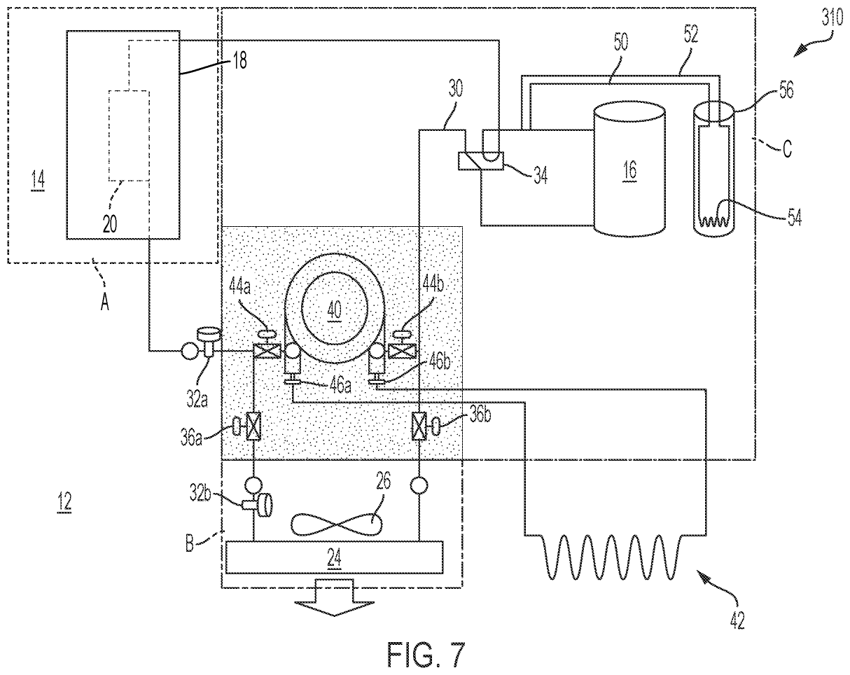

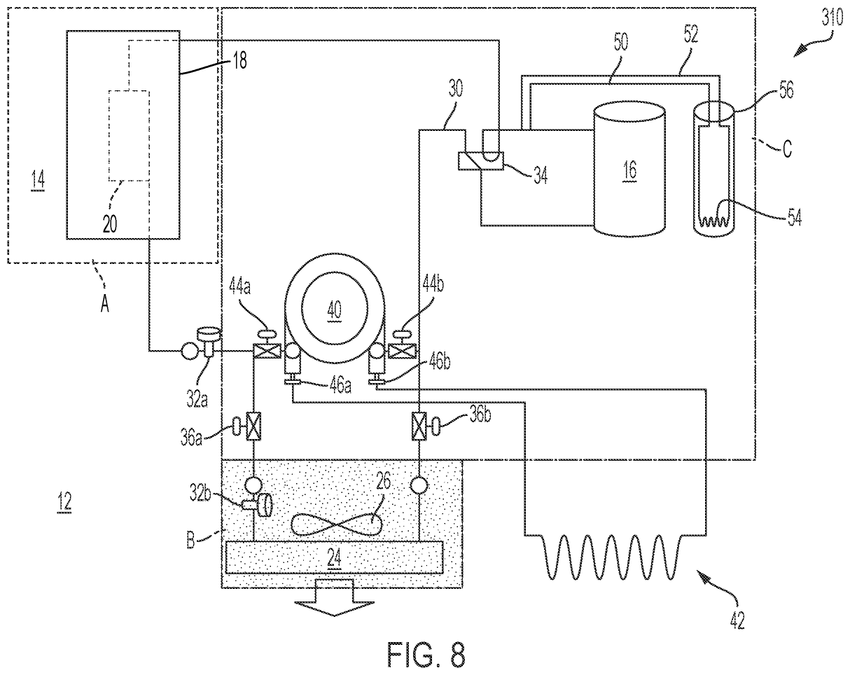

Turning to FIGS. 7 and 8, another alternative configuration in accordance with the present disclosure is shown as heat pump system 310. System 310 includes bounding box A representative of an indoor cabinet containing indoor heat pump 18 within interior air space 14, and may optionally include hot water tank 56 as shown and described with respect to FIGS. 5 and 6. An outdoor cabinet contains the components of bounding box B, and includes only the outdoor heat exchanger 24 and its associated components, as shown and described with respect to FIGS. 1 and 2.

System 310 further includes a third cabinet including the components of bounding box C, which may be located either within interior space 14 or outside of the building in ambient environment 12. Bounding box C may include hot water tank 56 in some embodiments, such as those where the third cabinet is located indoors. Where the third cabinet is located outdoors, or extend refrigerant lines 50 and 52 either passing solely within the interior space 14.

The embodiment of FIGS. 7 and 8 facilitates flexible installation either indoors or outdoors, such that the decision on whether to install indoors or outdoors may be made on-site or shortly before the installation. Hot water tank 56 and heat exchanger 54 may be optionally included, as noted above with respect to systems 10, 110 and 210, with refrigerant lines 50 and 52 either passing solely within the interior space 14 where bounding box C.

FIG. 7 illustrates geothermal heat exchanger 40 and its associated components as functionally isolated from the other components of system 310, i.e., when geothermal heat source/sink 42 is not yet installed and/or operational. Thus, some of the components with the third cabinet of bounding box C are selectively operational while other are operational regardless of the presence of absence of geothermal heat source/sink 42. When heat exchanger 24 and its associated components are isolated, the components of bounding box B are isolated in a similar fashion shown and described with respect to FIG. 2.

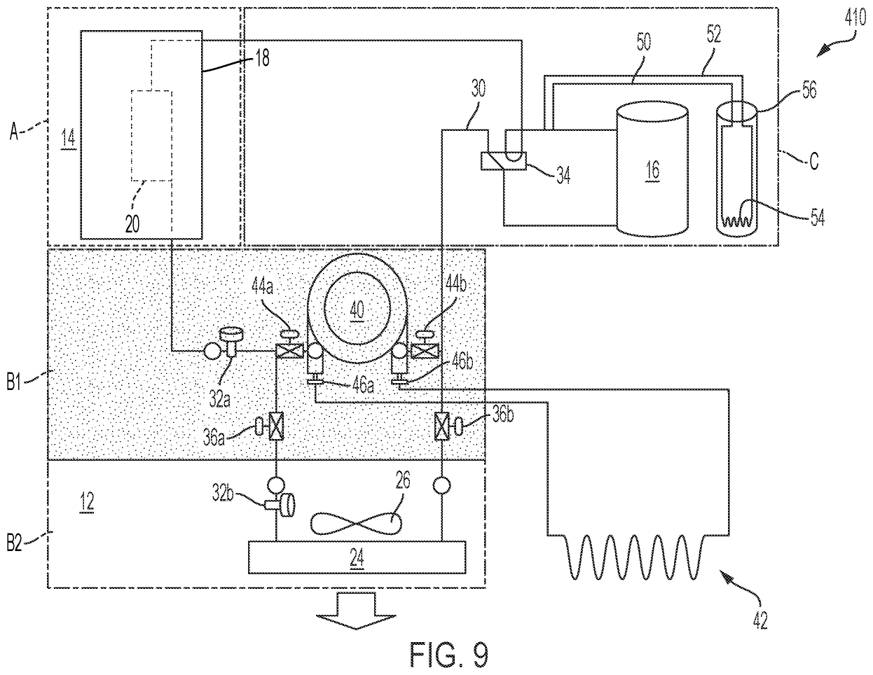

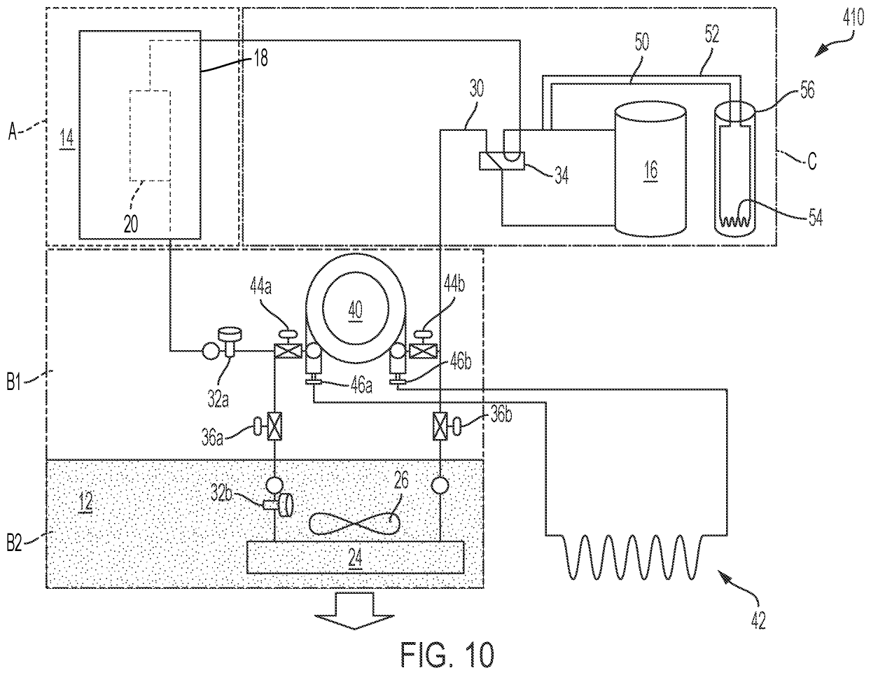

Turning to FIGS. 9 and 10, another alternative configuration in accordance with the present disclosure is shown as heat pump system 410. System 410 includes bounding box A indicative of a cabinet contained within interior space 14, which includes heat pump 18 as described in detail above with respect to FIGS. 5-8. However, system 410 also includes bounding boxes B1 and B2 respectively containing heat exchangers 40 and 24 and their associated components. Bounding boxes B1 and B2 are indicative of two cabinets designed to be placed outside of the building in ambient environment 12, similar to the separate outdoor cabinets described with reference to bounding boxes B and C shown in FIGS. 3 and 4.

In particular, heat exchanger 24 and the other components within bounding box B2 may be installed and functionally integrated with the other components of system 410 by installing a first outdoor cabinet in ambient environment 12 outside the building. The second cabinet, including geothermal heat exchanger 40 and its associated components within bounding box B1, may be excluded entirely and not installed, with appropriate fluid connections made within refrigerant loop 30. Fluid connections may be made ready and available outside the building in ambient environment 12 for connections to valve 34 and heat pump 18.

When geothermal heat source/sink 42 is installed and operating, the first cabinet represented by bounding box B2 may be removed and the second cabinet of bounding box B1 may be installed, as shown schematically in FIG. 10. At this point, outdoor heat exchanger 24 becomes functionally isolated by its absence, while geothermal heat exchanger 40 becomes functionally integrated by its presence and connection to the other components of system 410. Optionally, the first cabinet of bounding box B2 may remain in place and connected. However, with this separate-cabinet arrangement, only the components presently in service need to be made available at the service site, while the other, isolated components may be placed in service elsewhere.

System 410 of FIGS. 9 and 10 further includes bounding box C, which includes the balance of the components of system 410 such as compressor 16, valve 34, and optionally hot water tank 56. Bounding box C may be indicative of a further cabinet which may be placed within interior space 14 or outside of the building in ambient environment 12, similar to the cabinet corresponding to bounding box C shown and described with reference to FIGS. 7 and 8.

Advantageously, the arrangement of FIGS. 9 and 10 allows for complete flexibility and modularity on the spatial arrangement of components for system 410 either indoors, within interior space 14, or outdoors, in ambient environment 12. This allows an installed to make on-site or otherwise delayed decisions on the placement of individual component groups, thereby allowing for optimization of system 410 within the prevailing spatial or technical constraints of a particular installation site.

Where the cabinet of bounding box C is placed indoors, it may include hot water tank 56 and heat exchanger 54 as shown in FIGS. 9 and 10 and described in detail above with respect to, e.g., systems 10 and 110. Where the cabinet of bounding box C is placed outdoors, it may exclude hot water tank 56 and heat exchanger 54, or may include these components within interior space 14 as shown and described with respect to FIGS. 5 and 6.

### ASPECTS

Aspect 1 is a heat pump system, including a compressor, a first, inside heat exchanger, a second, outside heat exchanger, a geothermal, refrigerant-to-water heat exchanger, an expansion device, and a refrigerant loop communicating the compressor, the first and second heat exchangers, the geothermal heat exchanger, and the expansion device. The geothermal, refrigerant-to-water heat exchanger includes a first geothermal loop connection port including a first isolation valve and second geothermal loop connection port including a second isolation valve.

Aspect 2 is the heat pump system of Aspect 1, wherein the outside heat exchanger is an air source heat exchanger.

Aspect 3 is the heat pump system of Aspect 1 or Aspect 2, wherein the inside heat exchanger is one of an air source heat exchanger and a hydronic heat exchanger.

Aspect 4 is the heat pump system of any of Aspects 1-3, wherein the geothermal heat exchanger is one of a coaxial heat exchanger and a brazed plate heat exchanger.

Aspect 5 is the heat pump system of any of Aspects 1-4, wherein the geothermal heat exchanger is in heat exchange relationship with a water loop geothermal heat source/sink.

Aspect 6 is the heat pump system of any of Aspects 1-5, wherein the compressor, first heat exchanger, and geothermal heat exchanger are located inside of a building, and the second heat exchanger is located outside of the building.

Aspect 7 is the heat pump system of any of Aspects 1-5, wherein the second heat exchanger and the geothermal heat exchanger are both contained in an outdoor cabinet located outside of a building.

Aspect 8 is the heat pump system of Aspect 7, wherein the outdoor cabinet further includes the compressor.

Aspect 9 is the heat pump system of any of Aspects 1-8, further comprising a hot water tank having a hot water heat exchanger, the hot water heat exchanger connected to the refrigerant loop and configured to receive refrigerant from an outlet of the compressor.

Aspect 10 is, in combination, a building including an interior space, and a heat pump system. The heat pump system includes a first heat exchanger located within the building interior space, a second heat exchanger disposed exteriorly of the building interior space, a geothermal heat exchanger, a compressor, and an expansion device each disposed in one of the building interior space and exteriorly of the building interior space, and a refrigerant loop communicating the compressor, the first heat exchanger, the geothermal heat exchanger, the expansion device, and the second heat exchanger.

Aspect 11 is the combination of Aspect 10, wherein the geothermal heat exchanger is one of a coaxial heat exchanger and a brazed plate heat exchanger.

Aspect 12 is the combination of Aspect 10 or Aspect 11, wherein the geothermal heat exchanger is in heat exchange relationship with a water loop geothermal heat source/sink disposed exteriorly of the building.

Aspect 13 is the combination of any of Aspects 10-12, wherein the geothermal heat exchanger further includes a first geothermal loop connection port including a first isolation valve, and a second geothermal loop connection port including a second isolation valve.

Aspect 14 is the combination of any of Aspects 10-13, wherein the second heat exchanger is an air source heat exchanger.

Aspect 15 is the combination of any of Aspects 10-14, wherein the first heat exchanger is one of an air source heat exchanger and a hydronic heat exchanger.

Aspect 16 is a method of operating a heat pump system, including operating an installed heat pump system to exchange heat by refrigerant flow between a first heat exchanger disposed within an interior space of a building and a second heat exchanger disposed in an ambient environment exterior to the building to heat or cool the interior space, the installed heat pump system also including a geothermal heat exchanger, connecting a water source geothermal heat source/sink to the geothermal heat exchanger, and operating the heat pump system by refrigerant flow to exchange heat between the first heat exchanger and the geothermal heat exchanger to heat or cool the interior space.

Aspect 17 is the method of Aspect 16, wherein the geothermal heat exchanger is disposed within one of the interior space and the ambient environment exterior to the building.

Aspect 18 is the method of Aspect 16 or Aspect 17, wherein the connecting step comprises connecting geothermal loop connection ports of the geothermal heat exchanger to a water loop geothermal heat source/sink disposed in the ambient environment exterior to the building.

Aspect 19 is the method of any of Aspects 16-18, wherein the geothermal heat exchanger is one of a coaxial heat exchanger and a brazed plate heat exchanger.

Aspect 20 is the method of any of Aspects 16-19, wherein the second heat exchanger is an air source heat exchanger, and the first heat exchanger is one of an air source heat exchanger and a hydronic heat exchanger.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A heat pump system, comprising:
a compressor;
a first, inside heat exchanger;
a second, outside heat exchanger;
a geothermal, refrigerant-to-water heat exchanger comprising:
a first geothermal loop connection port including a first isolation valve; and
a second geothermal loop connection port including a second isolation valve;
an expansion device; and
a refrigerant loop communicating the compressor, the first and second heat exchangers, the geothermal heat exchanger, and the expansion device.

2. The heat pump system of claim 1, wherein the outside heat exchanger is an air source heat exchanger.

3. The heat pump system of claim 2, wherein the inside heat exchanger is one of an air source heat exchanger and a hydronic heat exchanger.

4. The heat pump system of claim 1, wherein the geothermal heat exchanger is one of a coaxial heat exchanger and a brazed plate heat exchanger.

5. The heat pump system of claim 1, wherein the geothermal heat exchanger is in heat exchange relationship with a water loop geothermal heat source/sink.

6. The heat pump system of claim 1, wherein the compressor, first heat exchanger, and geothermal heat exchanger are located inside of a building, and the second heat exchanger is located outside of the building.

7. The heat pump system of claim 1, wherein the second heat exchanger and the geothermal heat exchanger are both contained in an outdoor cabinet located outside of a building.

8. The heat pump system of claim 7, wherein the outdoor cabinet further includes the compressor.

9. The heat pump system of claim 1, further comprising a hot water tank having a hot water heat exchanger, the hot water heat exchanger connected to the refrigerant loop and configured to receive refrigerant from an outlet of the compressor.

10. In combination:
a building including an interior space; and
a heat pump system, comprising:
a first heat exchanger located within the building interior space;
a second heat exchanger disposed exteriorly of the building interior space;
a geothermal heat exchanger, a compressor, and an expansion device each disposed in one of the building interior space and exteriorly of the building interior space; and
a refrigerant loop communicating the compressor, the first heat exchanger, the geothermal heat exchanger, the expansion device, and the second heat exchanger.

11. The combination of claim 10, wherein the geothermal heat exchanger is one of a coaxial heat exchanger and a brazed plate heat exchanger.

12. The combination of claim 10, wherein the geothermal heat exchanger is in heat exchange relationship with a water loop geothermal heat source/sink disposed exteriorly of the building.

13. The combination of claim 10, wherein the geothermal heat exchanger further comprises:
a first geothermal loop connection port including a first isolation valve; and
a second geothermal loop connection port including a second isolation valve.

14. The combination of claim 10, wherein the second heat exchanger is an air source heat exchanger.

15. The combination of claim 14, wherein the first heat exchanger is one of an air source heat exchanger and a hydronic heat exchanger.

16. A method of operating a heat pump system, comprising:
operating an installed heat pump system to exchange heat by refrigerant flow between a first heat exchanger disposed within an interior space of a building and a second heat exchanger disposed in an ambient environment exterior to the building to heat or cool the interior space, the installed heat pump system also including a geothermal heat exchanger;
connecting a water source geothermal heat source/sink to the geothermal heat exchanger; and
operating the heat pump system by refrigerant flow to exchange heat between the first heat exchanger and the geothermal heat exchanger to heat or cool the interior space.

17. The method of claim 16, wherein the geothermal heat exchanger is disposed within one of the interior space and the ambient environment exterior to the building.

18. The method of claim 16, wherein the connecting step comprises connecting geothermal loop connection ports of the geothermal heat exchanger to a water loop geothermal heat source/sink disposed in the ambient environment exterior to the building.

19. The method of claim 16, wherein the geothermal heat exchanger is one of a coaxial heat exchanger and a brazed plate heat exchanger.

20. The method of claim 16, wherein the second heat exchanger is an air source heat exchanger, and the first heat exchanger is one of an air source heat exchanger and a hydronic heat exchanger.
